(19) United States
(12) Patent Application Publication
(10) Pub. No.: US 2008/0103766 A1
(43) Pub. Date: May 1, 2008

(54) AUDIENCE RESPONSE DETECTION INTERACTIVE PRESENTATION TOOL

(76) Inventors: Cary L. Bates, Rochester, MN (US); Waheed Sujjad, LaVergne, TN (US)

Correspondence Address: HOFFMAN, WARNICK & D'ALESSANDRO LLC, 75 STATE ST, 14TH FLOOR, ALBANY, NY, 12207, US

(21) Appl. No.: 11/553,662

(22) Filed: Oct. 27, 2006

(51) Int. Cl. G10L 21/02

(52) U.S. Cl. 704/226

(57) ABSTRACT

The invention is directed to an audience response detection interactive presentation tool. An interactive method for controlling a presentation in accordance with an embodiment of the present invention includes: presenting a slide to an audience during a presentation; activating a noise level measuring system; measuring audience noise as a pointer is successively positioned over each of a plurality of selection mechanisms; deactivating the noise level measuring system; automatically selecting the selection mechanism associated with the loudest measured audience noise; and automatically performing a predetermined action based on the selected selection mechanism.

### BACKGROUND OF THE INVENTION

1. Field of the Invention

The present invention generally relates to presentations. More specifically, the present invention is directed to an audience response detection interactive presentation tool.

2. Related Art

Often, during a presentation, an audience will be presented with a question (e.g., a “Yes” or “No” question, a choice between option “A” or “B,” etc.). Unfortunately, currently available presentation software does not allow the presenter to automatically display a slide or take some action based on the audience's answer to the question.

### SUMMARY OF THE INVENTION

The present invention is directed to an audience response detection interactive presentation tool. In particular, in one embodiment, the level of audience noise generated in response to a question posed during a computer-generated presentation is measured. This is done as the presenter positions a cursor over each of a plurality of possible audience responses to the question (e.g., “Yes” or “No,” choice “A” or “B”, etc.). The audience response to the question having the highest noise level is automatically selected by the presentation tool, which then causes an action (e.g., the display of a slide) to be performed based on the audience's response.

A first aspect of the present invention is directed to an interactive method for controlling a presentation, comprising: presenting a slide to an audience during a presentation; activating a noise level measuring system; measuring audience noise as a pointer is successively positioned over each of a plurality of selection mechanisms; deactivating the noise level measuring system; automatically selecting the selection mechanism associated with the loudest measured audience noise; and automatically performing a predetermined action based on the selected selection mechanism.

A second aspect of the present invention is directed to an interactive presentation tool for controlling a presentation, comprising: a system for presenting a slide to an audience during a presentation; a system for activating a noise level measuring system and for measuring audience noise as a pointer is successively positioned over each of a plurality of selection mechanisms; a system for deactivating the noise level measuring system; a system for automatically selecting the selection mechanism associated with the loudest measured audience noise; and a system for automatically performing a predetermined action based on the selected selection mechanism.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative audience response detection interactive presentation tool in accordance with an embodiment of the present invention.

FIG. 2 depicts an illustrative presentation slide in accordance with the present invention.

FIG. 3 depicts a flow diagram of an illustrative process in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As described above, the present invention is directed to an audience response detection interactive presentation tool. In particular, in one embodiment, the level of audience noise generated in response to a question posed during a computer generated presentation is measured. This is done as the presenter positions a cursor over each of a plurality of possible audience responses to the question (e.g., “Yes” or “No,” choice “A” or “B”, etc.). The audience response to the question having the highest noise level is automatically selected by the presentation tool, which then causes an action (e.g., the display of a slide) to be performed based on the audience's response.

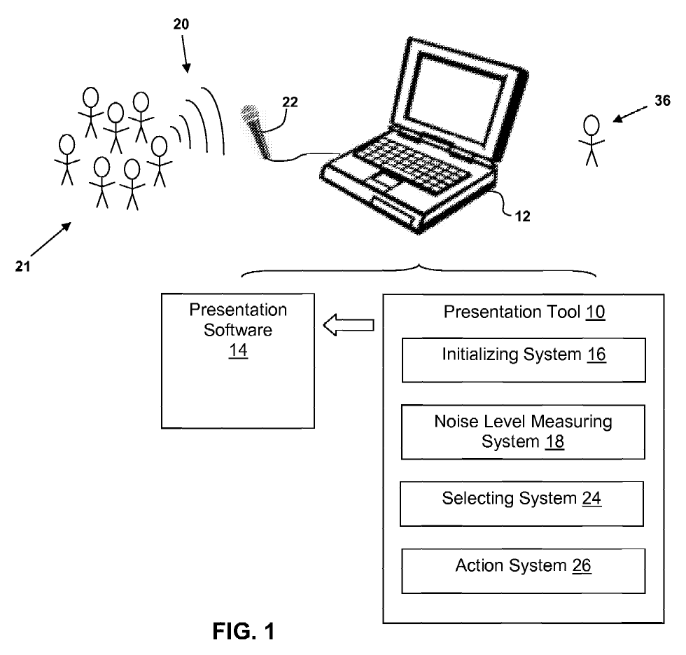

An illustrative audience response detection interactive presentation tool 10 (hereafter “presentation tool” 10) in accordance with an embodiment of the present invention is depicted in FIG. 1. The presentation tool 10 runs on a computer system 12, and can be provided as a plug-in for presentation software 14 or as a stand-alone application.

The presentation tool 10 includes an initializing system 16 for activating/deactivating a noise level measuring system 18 for measuring the noise 20 (e.g., applause, whistles, etc.) generated by an audience 21 of a presentation. The audience noise 20 is input into the computer system 12 via a built-in or external microphone 22. The presentation tool 10 further includes a selecting system 24 for automatically selecting the audience response to a question having the highest noise level, and an action system 26 for performing an action based on the audience's response.

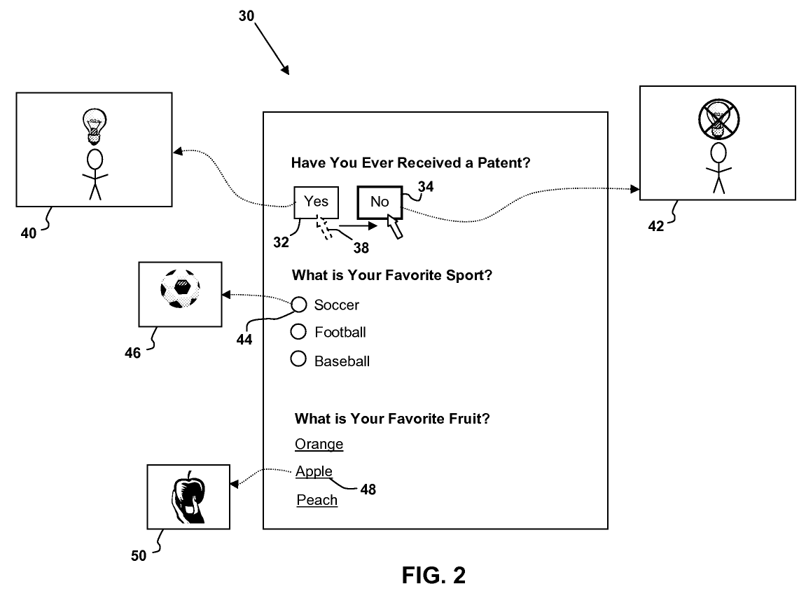

An illustrative presentation slide 30 generated by the presentation software 14 and presentation tool 10 of the present invention is depicted in FIG. 2. In a first portion of the slide 30, the following question is posed to the audience 21: “Have You Ever Received a Patent?” This question can be answered using either the “Yes” button 32 or “No” button 34.

In accordance with the present invention, the presenter 36 activates the noise level measuring system 18 of the presentation tool 10 using the initializing system 16. For example, the noise level measuring system 18 can be activated by holding down a key or key combination (e.g. the “Alt” key). Other techniques for activating the noise level measuring system 18 are also possible. Examples include a menu selection, toolbar button selection, etc. When activated, the noise level measuring system 18 measures audience noise 20 input into the computer system 12 via the built-in or external microphone 22.

Once the noise level measuring system 18 is activated, and after the audience 21 has been instructed regarding the use of the present invention, the presenter 36 positions a cursor 38 (or other pointer) over each of the buttons 32, 34, in succession, while the audience noise 20 is measured by the noise level measuring system 18. The presenter 36 could also tab through the buttons 32, 34. To assist the audience 21, each of the buttons 32, 34 can be highlighted when the cursor 38 is positioned thereon. The presenter 36 then deactivates the noise level measuring system 18 using the initializing system 16 (e.g., by releasing the “Alt” key). The selecting system 24 of the presentation tool 10 then automatically selects the button 32 or 34 which triggered the loudest audience noise 20, and the action system 26 automatically performs a predetermined action based on the selected button 32, 34.

As shown in FIG. 2, if the audience noise 20 was louder when the cursor 38 was positioned over the button 32 (“Yes”), the action system 26 causes a first slide 40 to be presented to the audience 21. Contrastingly, if the audience noise 20 was louder when the cursor 38 was positioned over the button 34 (“No”), the action system 26 causes a second, different slide 42 to be presented to the audience 21. Other types of actions are possible and fall within the scope of the present invention.

The presentation tool 10 of the present invention can be used with radio buttons, hyperlinks, and other types of selection mechanisms. For instance, if the audience noise 20 was loudest when the cursor 38 was positioned over the radio button 44 (“Soccer”), in response to the question “What is Your Favorite Sport,” the action system 26 causes a slide 46 to be presented to the audience 21. Similarly, if the if the audience noise 20 was loudest when the cursor 38 was positioned over the hyperlink 48 (“Apple”), in response to the question “What is Your Favorite Fruit,” the action system 26 causes a slide 50 to be presented to the audience 21. Again, other types of actions are possible and fall within the scope of the present invention.

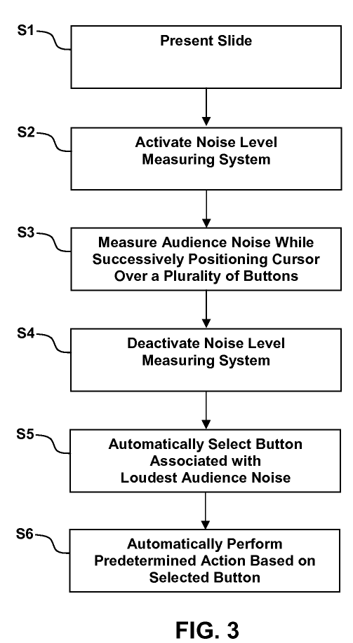

A flow diagram of an illustrative process in accordance with an embodiment of the present invention is depicted in FIG. 3. In step S1, a slide is presented during a presentation. In step S2, a presenter activates the noise level measuring system of the presentation tool. In step S3, audience noise is measured while a cursor is successively positioned over each of a plurality of buttons or the like. In step S4, the presenter deactivates the noise level measuring system. In step S5, the button associated with the loudest audience noise is automatically selected. In step S6, a predetermined action is automatically performed based on the selected button.

Some/all aspects of the present invention can be provided on a computer-readable medium that includes computer program code for carrying out and/or implementing the various process steps of the present invention, when loaded and executed in a computer system. It is understood that the term “computer-readable medium” comprises one or more of any type of physical embodiment of the computer program code. For example, the computer-readable medium can comprise computer program code embodied on one or more portable storage articles of manufacture (e.g., a compact disc, a magnetic disk, a tape, etc.), on one or more data storage portions of a computer system, such as memory and/or a storage system (e.g., a fixed disk, a read-only memory, a random access memory, a cache memory, etc.), and/or as a data signal traveling over a network (e.g., during a wired/wireless electronic distribution of the computer program code).

It should be appreciated that the teachings of the present invention could be offered as a business method on a subscription or fee basis. For example, a service provider can create, maintain, enable, and deploy an audience response detection interactive presentation tool, as described above.

The foregoing description of the embodiments of this invention has been presented for purposes of illustration and description. It is not intended to be exhaustive or to limit the invention to the precise form disclosed, and many modifications and variations are possible.

What is claimed is:

1. An interactive method for controlling a presentation, comprising:
presenting a slide to an audience during a presentation;
activating a noise level measuring system;
measuring audience noise as a pointer is successively positioned over each of a plurality of selection mechanisms;
deactivating the noise level measuring system;
automatically selecting the selection mechanism associated with the loudest measured audience noise; and
automatically performing a predetermined action based on the selected selection mechanism.

2. The method of claim 1, wherein the selection mechanism is selected from the group consisting of a button, a radio button, and a hyperlink.

3. The method of claim 1, wherein the predetermined action comprises presenting a predetermined slide to the audience.

4. An interactive presentation tool for controlling a presentation, comprising:
a system for presenting a slide to an audience during t presentation;
a system for activating a noise level measuring system and for measuring audience noise as a pointer is successively positioned over each of a plurality of selection mechanisms;
a system for deactivating the noise level measuring system;
a system for automatically selecting the selection mechanism associated with the loudest measured audience noise; and
a system for automatically performing a predetermined action based on the selected selection mechanism.

5. The presentation tool of claim 4, wherein the selection mechanism is selected from the group consisting of a button, a radio button, and a hyperlink.

6. The presentation tool of claim 4, wherein the system for automatically performing a predetermined action based on the selected selection mechanism is configured to present a predetermined slide to the audience.

7. The presentation tool of claim 4, wherein the system for presenting a slide to an audience comprises a computer system running presentation software.

8. The presentation tool of claim 7, wherein the audience noise is input into the computer system via a microphone.

9. The presentation tool of claim 7, wherein the presentation tool is a plug-in for the presentation software.
